(19) United States
(12) Patent Application Publication
(10) Pub. No.: US 2018/0291228 A1
(43) Pub. Date: Oct. 11, 2018

(54) COMPOSITE RESIN AND COATED SUBSTRATE

(71) Applicant: TOYOTA JIDOSHA KABUSHIKI KAISHA, Toyota-shi (JP)

(72) Inventors: Satoshi TAKATA, Toyota-shi (JP); Motoki HIRAOKA, Toyota-shi (JP); Hiroshi YANAGIMOTO, Miyoshi-shi (JP)

(73) Assignee: TOYOTA JIDOSHA KABUSHIKI KAISHA, Toyota-shi (JP)

(21) Appl. No.: 15/941,701

(22) Filed: Mar. 30, 2018

(30) Foreign Application Priority Data
Apr. 7, 2017 (JP) 2017-076857

(51) Int. Cl. C09D 133/12; C08L 33/12; C08L 63/00; C09D 163/00

(52) U.S. Cl. CPC C09D 133/12; C08L 33/12; C08L 2205/03; C09D 163/00; C08L 63/00

(57) ABSTRACT

A composite resin includes an acrylic resin constituent unit, an epoxy resin constituent unit, and a polysiloxane constituent unit. A proportion of the polysiloxane constituent unit in the composite resin is 1.5 weight % to 12 weight % in terms of SiO₂. When the composite resin is used, it is possible to provide a coating film having high corrosion resistance.

### INCORPORATION BY REFERENCE

The disclosure of Japanese Patent Application No. 2017-076857 filed on Apr. 7, 2017 including the specification, drawings and abstract is incorporated herein by reference in its entirety.

### BACKGROUND OF THE INVENTION

### 1. Field of the Invention

The present invention relates to a composite resin. In addition, the present invention relates to a coated substrate covered with a coating film including a composite resin.

### 2. Description of Related Art

On a surface of a substrate used in various applications, a coating film having a function required for such applications may be formed. Examples of a function of the coating film can include corrosion resistance, water resistance, insulating properties, and weather resistance.

For example, Japanese Unexamined Patent Application Publication No. 2008-260018 (JP 2008-260018 A) discloses that, in order to impart weather resistance and a rust prevention property, an adhesion-imparting coating film (A) including (a) a moisture curable resin, (b) a rust preventive pigment, (c) a corrosive ion fixing agent, and (d) a coupling agent is formed on a surface of a weather resistant steel, and next, a colored top coating film (B) with a dry film thickness of 50 μm to 90 μm is formed.

In addition, Japanese Unexamined Patent Application Publication No. 2007-197820 (2007-197820 A) discloses that, in order to impart corrosion resistance, an insulating film including a composite resin made of a polysiloxane and a polymer containing elemental C is formed on a surface of an electromagnetic steel sheet.

### SUMMARY OF THE INVENTION

In JP 2008-260018 A and 2007-197820 A, when a predetermined test (for example, wet test, salt spray test) is performed, it can be confirmed that a coating film has desired functions. However, such coating films cannot withstand severer conditions, for example, condensed water having the following composition (Cl⁻: 4,000 ppm, SO₄²⁻: 2,000 ppm, pH 2). Therefore, the present invention provides a coating film having high corrosion resistance and a composite resin for the coating film.

The inventors and the like found that, when a composite resin in which an acrylic resin, an epoxy resin, and a polysiloxane are combined at constituent unit (monomer) levels thereof is used and an amount of polysiloxane in the composite resin is set to be within a predetermined range, a coating film formed of the composite resin has high corrosion resistance.

A first aspect of the present invention relates to a composite resin. The composite resin includes an acrylic resin constituent unit, an epoxy resin constituent unit, and a polysiloxane constituent unit. A proportion of the polysiloxane constituent unit in the composite resin is 1.5 weight % to 12 weight % in terms of SiO₂.

The proportion of the polysiloxane constituent unit in the composite resin may be 2 weight % to 10 weight % in terms of SiO₂.

A second aspect of the present invention relates to a coated substrate that includes a substrate and a coating film that covers the substrate and includes the above composite resin. The substrate may be a metal substrate having hydroxyl groups on its surface. The coating film may have a thickness of 1 μm to 50 μm.

According to the present invention, it is possible to provide a coating film having high corrosion resistance and a composite resin for the coating film.

### DETAILED DESCRIPTION OF EMBODIMENTS

### Composite Resin

An embodiment of the present invention relates to a composite resin including an acrylic resin constituent unit, an epoxy resin constituent unit, and a polysiloxane constituent unit. A proportion of the polysiloxane constituent unit in the composite resin is 1.5 weight % to 12 weight % in terms of SiO₂. According to the present embodiment, when the composite resin is applied to a substrate as a coating film, it is possible to impart high corrosion resistance.

According to the present embodiment, in the composite resin, an acrylic resin, an epoxy resin, and a polysiloxane are combined at constituent unit (monomer) levels thereof.

The “acrylic resin constituent unit” refers to a main unit constituting an acrylic resin. The acrylic resin constituent unit is derived from a main component forming an acrylic resin (hereinafter referred to as an “acrylic resin forming component”).

Examples of the acrylic resin forming component can include acrylic acid, an acrylic acid salt, an acrylic acid ester, methacrylic acid, a methacrylate, and a methacrylate ester. Examples of the acrylic acid ester can include methyl acrylate, ethyl acrylate, butyl acrylate, and 2-ethylhexyl acrylate. Examples of the methacrylic acid ester can include methyl methacrylate, ethyl methacrylate, butyl methacrylate, and 2-ethylhexyl methacrylate.

A proportion of the acrylic resin constituent unit in the composite resin can be, for example, 30 weight % to 60 weight %.

The “epoxy resin constituent unit” refers to a main unit constituting an epoxy resin. The epoxy resin constituent unit is derived from a main component forming an epoxy resin (hereinafter, the main component will be referred to as an “epoxy resin forming component”).

Examples of the epoxy resin forming component can include bisphenol A+epichlorohydrin, bisphenol A glycidyl ether, and bisphenol F glycidyl ether.

A proportion of the epoxy resin constituent unit in the composite resin can be, for example, 30 weight % to 60 weight %.

The “polysiloxane constituent unit” refers to a main unit constituting a polysiloxane. The polysiloxane constituent unit is derived from a main component forming a polysiloxane (hereinafter referred to as a “polysiloxane forming component”).

As the polysiloxane forming component, for example, a silane compound having a hydroxyl group, an alkoxy group, or the like can be exemplified. As the silane compound, for example, SiR1¹ₙR²₄₋ₙ can be exemplified. In the expression, each R¹ independently represents a hydroxyl group or an alkoxyl group, each R² independently represents hydrogen or an alkyl group, and n is an integer of 1 to 4, preferably, an integer of 2 to 4, more preferably, an integer of 3 or 4, and particularly preferably, the integer of 4. As a specific silane compound, for example, tetraethoxysilane, and tetramethoxysilane can be exemplified.

A proportion of the polysiloxane constituent unit in the composite resin (hereinafter referred to as a “polysiloxane proportion”) is 1.5 weight % to 12 weight %, and preferably 2 weight % to 10 weight % in terms of SiO₂. With such a proportion, it is possible to impart flexibility to the coating film formed of the composite resin, and it is possible to improve adhesiveness between the coating film and the substrate.

The polysiloxane proportion (weight % in terms of SiO₂) can be determined by an electron beam microanalyzer (EPMA).

The composite resin may include other constituent units in addition to the acrylic resin constituent unit, the epoxy resin constituent unit, and the polysiloxane constituent unit in a range in which the effects of the present invention are not impaired.

Since the acrylic resin forming component has many reaction points with respect to the polysiloxane forming component, the structure of the coating film can be densified. In addition, the epoxy resin forming component can impart water resistance to the coating film. Furthermore, when a predetermined amount of the polysiloxane forming component is used, it is possible to impart flexibility to the coating film and it is possible to improve adhesiveness between the coating film and the substrate. According to such effects, the coating film has high corrosion resistance.

### Coated Substrate

An embodiment of the present invention relates to a coated substrate that includes a substrate and a coating film that covers the substrate and includes the composite resin. The coating film including the composite resin has high corrosion resistance.

Examples of the substrate can include a metal substrate. Although not particularly limited, as the metal substrate, a metal substrate having hydroxyl groups on its surface is preferably used. When the hydroxyl groups on the surface of the metal substrate and the hydroxyl groups on the coating film are dehydrated and condensed, it is possible to improve adhesiveness between the substrate and the coating film.

As a specific metal substrate, for example, an iron substrate, an aluminum substrate, a stainless substrate, and a steel substrate can be exemplified.

The thickness of the coating film is preferably 1 μm to 50 μm and more preferably 2 μm to 40 μm. In such a film thickness, it is possible to further improve corrosion resistance of the coating film.

A method of covering the substrate with the coating film is not particularly limited and various methods known to those skilled in the art can be used. For example, when a solution including raw materials of the coating film is applied to the substrate and the substrate is heated, it is possible to form the coating film on the substrate.

A method of applying the solution including the raw materials of the coating film to the substrate is not particularly limited, and various methods known to those skilled in the art can be used. For example, an immersion method, a spraying method, or a bar coater method can be used.

The coating film may include other components in addition to the composite resin in a range in which the effects of the present invention are not impaired. A proportion of the composite resin in the coating film can be, for example, 70 weight % or more, 75 weight % or more, 80 weight % or more, 85 weight % or more, 90 weight % or more, or 95 weight % or more.

The coated substrate according to the present embodiment can be used in various applications. For example, the coated substrate can be used as an automobile component (for example, an EGR pipe, and an injector nozzle) with which condensed water comes in contact.

The present invention will be described below in detail with reference to examples and comparative examples, but the technical scope of the present invention is not limited thereto.

### Coating Film Material

(1) Acrylic resin constituent unit: methyl methacrylate (Acryl ester M: molecular weight 100, commercially available from Mitsubishi Rayon Co., Ltd.)
(2) Epoxy resin constituent unit: bisphenol A type epoxy resin (jER (registered trademark) epoxy resin: grade 828, molecular weight 370 commercially available from Mitsubishi Chemical Corporation)
(3) Polysiloxane constituent unit: tetraethoxysilane (LS-2430, commercially available from Shin-Etsu Chemical Co., Ltd.)

### Substrate

(1) Stainless substrate (SUS304)
(2) Aluminum substrate (A2618)

### Preparation of Test Substrate

Materials of the coating film were stirred at 60° C. for 3 hours to prepare a mixed solution. When methyl methacrylate and a bisphenol A type epoxy resin were used at the same time, the same weight of both materials was used. A weight of tetraethoxysilane used was that for a polysiloxane proportion (weight % in terms of SiO₂) shown in the following Tables 1 to 6.

The stainless substrate or the aluminum substrate was immersed in the prepared mixed solution. The substrate taken out of the mixed solution was heated in a hot air furnace at 200° C. for 30 minutes, and a test substrate on which the coating film was formed was prepared.

### Evaluation of Corrosion Resistance

A test solution (Cl⁻: 4,000 ppm, SO₄²⁻: 2,000 ppm, pH 2) was sprayed on the test substrate. At 120 hours after spraying, an incidence of rust on the test substrate was visually determined based on the area. The results are shown in the following Tables 1 to 6.

Determination criteria of the corrosion resistance were as follows.

A: Rust area proportion was 0% or more and less than 20%
B: Rust area proportion was 20% or more and less than 40%
C: Rust area proportion was 40% or more and less than 60%
D: Rust area proportion was 60% or more and less than 100%

TABLE 1
Evaluation of corrosion resistance of coating film
on stainless substrate (material examination)

| | | Polysiloxane | | |
|---|---|---|---|---|
| | | proportion | Film | |
| | Coating film | (weight % in | thickness | Corrosion |
| | materials | terms of SiO₂) | (μm) | resistance |
| Comparative | Methyl | 2 | 2.2 | D |
| Example 1-1 | methacrylate | | | |
| | Tetraethoxysilane | | | |
| Comparative | Bisphenol A type | | 2.1 | D |
| Example 1-2 | epoxy resin | | | |
| | Tetraethoxysilane | | | |
| Example 1 | Methyl | | 1.9 | A |
| | methacrylate | | | |
| | Bisphenol A type | | | |
| | epoxy resin | | | |
| | Tetraethoxysilane | | | |

TABLE 2
Evaluation of corrosion resistance of coating film
on aluminum substrate (material examination)

| | | Polysiloxane | | |
|---|---|---|---|---|
| | | proportion | Film | |
| | Coating film | (weight % in | thickness | Corrosion |
| | materials | terms of SiO₂) | (μm) | resistance |
| Comparative | Methyl | 2 | 2.1 | D |
| Example 2-1 | methacrylate | | | |
| | Tetraethoxysilane | | | |
| Comparative | Bisphenol A type | | 2.2 | D |
| Example 2-2 | epoxy resin | | | |
| | Tetraethoxysilane | | | |
| Example 2 | Methyl | | 2.0 | A |
| | methacrylate | | | |
| | Bisphenol A type | | | |
| | epoxy resin | | | |
| | Tetraethoxysilane | | | |

TABLE 3
Evaluation of corrosion resistance of coating
film on stainless substrate (SiO₂ examination)

| | | Polysiloxane | | |
|---|---|---|---|---|
| | | proportion | Film | |
| | Coating film | (weight % in | thickness | Corrosion |
| | materials | terms of SiO₂) | (μm) | resistance |
| Comparative | Methyl | 1 | 2.2 | C |
| Example 3-1 | methacrylate | | | |
| Example 3-1 | Bisphenol A type | 1.5 | 2.0 | B |
| Example 3-2 | epoxy resin | 2 | 1.9 | A |
| Example 3-3 | Tetraethoxysilane | 10 | 2.1 | A |
| Example 3-4 | | 12 | 2.1 | B |
| Comparative | | 15 | 1.9 | C |
| Example 3-2 | | | | |

TABLE 4
Evaluation of corrosion resistance of coating
film on aluminum substrate (SiO₂ examination)

| | | Polysiloxane | | |
|---|---|---|---|---|
| | | proportion | Film | |
| | Coating film | (weight % in | thickness | Corrosion |
| | materials | terms of SiO₂) | (μm) | resistance |
| Comparative | Methyl | 1 | 2.1 | C |
| Example 4-1 | methacrylate | | | |
| Example 4-1 | Bisphenol A type | 1.5 | 1.9 | B |
| Example 4-2 | epoxy resin | 2 | 2.0 | A |
| Example 4-3 | Tetraethoxysilane | 10 | 2.1 | A |
| Example 4-4 | | 12 | 2.2 | B |
| Comparative | | 15 | 2.0 | C |
| Example 4-2 | | | | |

TABLE 5
Evaluation of corrosion resistance of coating film
on stainless substrate (film thickness examination)

| | | Polysiloxane | | |
|---|---|---|---|---|
| | | proportion | Film | |
| | Coating film | (weight % in | thickness | Corrosion |
| | materials | terms of SiO₂) | (μm) | resistance |
| Example 5-1 | Methyl | 2 | 0.6 | B |
| Example 5-2 | methacrylate | | 1.0 | A |
| Example 5-3 | Bisphenol A type | | 1.9 | A |
| Example 5-4 | epoxy resin | | 39.8 | A |
| Example 5-5 | Tetraethoxysilane | | 50.3 | A |

TABLE 6
Evaluation of corrosion resistance of coating film
on aluminum substrate (film thickness examination)

| | | Polysiloxane | | |
|---|---|---|---|---|
| | | proportion | Film | |
| | Coating film | (weight % in | thickness | Corrosion |
| | materials | terms of SiO₂) | (μm) | resistance |
| Example 6-1 | Methyl | 2 | 0.5 | B |
| Example 6-2 | methacrylate | | 1.1 | A |
| Example 6-3 | Bisphenol A type | | 2.0 | A |
| Example 6-4 | epoxy resin | | 39.9 | A |
| Example 6-5 | Tetraethoxysilane | | 50.2 | A |

Table 1 and Table 2 show relationships between the coating film material and the corrosion resistance. Coating films (Comparative Example 1-1 and Comparative Example 2-1) made of a composite resin including an acrylic resin constituent unit and a polysiloxane constituent unit and coating films (Comparative Example 1-2 and Comparative Example 2-2) made of a composite resin including an epoxy resin constituent unit and a polysiloxane constituent unit had low corrosion resistance. On the other hand, the coating films (Example 1 and Example 2) made of a composite resin including an acrylic resin constituent unit, an epoxy resin constituent unit, and a polysiloxane constituent unit had high corrosion resistance.

Table 3 and Table 4 show relationships between the polysiloxane proportion and the corrosion resistance. Coating films (Examples 3-1 to 3-4 and Examples 4-1 to 4-4) with a polysiloxane proportion (weight % in terms of SiO₂) of 1.5 weight % to 12 weight % had high corrosion resistance and coating films (Examples 3-2 and 3-3 and Examples 4-2 and 4-3) with a polysiloxane proportion (weight % in terms of SiO₂) of 2 weight % to 10 weight % had particularly high corrosion resistance.

Table 5 and Table 6 show relationships between the thickness of the coating film and the corrosion resistance. Coating films (Examples 5-2 to 5-5 and Examples 6-2 to 6-5) with a film thickness of about 1 μm to 50 μm had particularly high corrosion resistance.

What is claimed is:

1. A composite resin comprising:
an acrylic resin constituent unit;
an epoxy resin constituent unit; and
a polysiloxane constituent unit
wherein a proportion of the polysiloxane constituent unit in the composite resin is 1.5 weight % to 12 weight % in terms of SiO₂.

2. The composite resin according to claim 1, wherein the proportion of the polysiloxane constituent unit in the composite resin is 2 weight % to 10 weight % in terms of SiO₂.

3. A coated substrate comprising:
a substrate; and
a coating film that covers the substrate and includes the composite resin according to claim 1.

4. The coated substrate according to claim 3, wherein the substrate is a metal substrate having hydroxyl groups on a surface of the metal substrate.

5. The coated substrate according to claim 3, wherein the coating film has a thickness of 1 μm to 50 μm.
